(19) United States
(12) Patent Application Publication
(10) Pub. No.: US 2025/0293724 A1
(43) Pub. Date: Sep. 18, 2025

(54) CASE FOR A MOBILE DEVICE

(71) Applicant: Bandwerk GmbH, Berg (DE)

(72) Inventors: Lukas Rossnagel, Heilbronn (DE); Merdan Demirci, Hannover (DE)

(21) Appl. No.: 18/902,804

(22) Filed: Sep. 30, 2024

(30) Foreign Application Priority Data
Mar. 18, 2024 (DE) 102024107694.1

(51) Int. Cl. H04B 1/3888; H04M 1/04

(52) U.S. Cl. CPC H04B 1/3888; H04M 1/04; H04M 2201/08

(57) ABSTRACT

The present invention relates to a case for a mobile device that has a frame with a first substantially L-shaped frame part and a second substantially L-shaped frame part, which are designed to jointly completely enclose side faces of the mobile device all around and to be fixedly connected to one another.

### CROSS REFERENCE TO RELATED APPLICATIONS

The present application claims priority to and the benefit of German Patent Application 102024107694.1, filed on Mar. 18, 2024, and entitled, “CASE FOR A MOBILE DEVICE, PREFERABLY FOR A SMARTPHONE,” the contents of which are incorporated herein by reference in its entirety.

### BACKGROUND

The present invention relates to a case for a mobile device, preferably for a smartphone.

The development and spread of mobile phones as portable telephones, which communicate with a telephone network via radio and can therefore be used regardless of location, has led to people being able to make calls and be reached at all times while on the go. Mobile phones were primarily designed based upon technical requirements, meaning they essentially had a keypad and a relatively small display, which essentially served to show the telephone number of the person being called.

Starting in 2007, so-called smartphones emerged, which are Internet-enabled mobile phones having touch-sensitive screens and have now completely replaced conventional mobile phones. Due to the constant availability of the Internet connection via mobile data networks instead of a traditional phone network, and because of the touch-sensitive display's operation and viewing capabilities, the function of making phone calls has significantly, if not completely, receded into the background. Instead, smartphones are primarily used for Internet browsing, social media, photography, and exchanging text messages.

This clearly emotional and pleasure-oriented or enjoyment-oriented use of smartphones, compared to the more rational and technical use of mobile phones, not only leads to a much more intense and frequent use of smartphones, but also increases the user's desire to protect and personalize their smartphone. For many users, the smartphone is an accessory, and not just a purely utilitarian object.

It is therefore known to use wallet cases, cases, and the like for smartphones, in order to protect a smartphone from falls and other mechanical damage as well as from heat, cold, moisture, dirt, and the like. For this purpose, individual elements such as a protective film can be used to cover the screen transparently. Cases can enclose the smartphone from the sides and back, and leave the screen free. A wallet case can accommodate the smartphone and can be opened and closed in order to access the smartphone or to cover it, wherein such wallet cases can also have slots for credit cards and the like. Cases and wallet cases for smartphones can also be designed to be visually appealing in order to realize the aspect described above of an accessory for the user. In any case, cases and wallet cases for smartphones can consist of plastic, artificial leather, and/or textiles, or have these materials.

More specifically, various product names for cases and wallet cases for smartphones have been established. “Hard cases” and “soft cases” are used as covers for smartphones, wherein hard cases usually use comparatively hard materials such as plastic, and soft cases usually using comparatively soft materials such as silicone. A “bumper” is usually a frame made of a relatively hard material that fits around the side faces of the smartphone and serves to cushion an impact, similarly to a bumper in a vehicle. Bumpers are made in one piece, i.e., integrally from one piece. A “flip case” or “pouch” is understood to mean an accessory that encases the entire smartphone and can be opened like a book or a wallet, which is why flip cases or pouches must be precisely tailored to the size of the smartphone. A “slim case” is made in one piece from a comparatively soft material such as neoprene and fits snugly against the smartphone. A “back cover” covers the rear of the smartphone. A “hybrid cover” usually consists of two parts, wherein an inner case made of a comparatively soft material such as silicone encloses the smartphone and is clamped into an outer cover. The hybrid cover is also known as an outdoor case or outdoor cover.

This applies in principle to tablets and the like, which together with smartphones can be described as mobile devices. However, due to their size, tablets are more likely to be used at home or in a fixed location and are usually used by several people in a household, and are thus usually less personalized than smartphones.

### SUMMARY

An object of the present invention is to provide a case for a mobile device, preferably for a smartphone, of the type described above, so that the technical and/or design possibilities can be expanded or improved. In particular, this is intended to protect the mobile device from mechanical influences, moisture, dirt, and the like. At least an alternative to the known possibilities is to be created.

According to the invention, the object is achieved by a case for a mobile device having the features of claim 1. Advantageous further developments are described in the subclaims.

Thus, the present invention relates to a case for a mobile device, preferably for a smartphone, having a frame with a first, preferably substantially L-shaped, frame part and a second, preferably substantially L-shaped, frame part, which are designed to jointly completely enclose side faces of the mobile device all around and to be fixedly connected to one another. The side faces of the mobile device extend around the mobile device and are arranged immediately adjacent to and at right angles to the front and rear of the mobile device.

According to the invention, a case for a mobile device can thus be created, which can initially have only a frame in the form of a so-called bumper. Further additional elements of the case according to the invention are added and described below. As a bumper, the frame can act as a case to provide appropriate protection for the mobile device.

According to the invention, having the frame consist of exactly two frame parts or frame elements can be advantageous in that, as the material of the frame or its frame parts, a comparatively rigid material such as a correspondingly strong plastic or metal can be used, which would not be able to be bent or stretched, in order to be pressed over the side faces of the mobile device in an endlessly closed design. Due to the segmented design of the frame, whether as separate frame parts or as connected frame parts that are movable relative to one another, the two rigid frame parts can be pushed onto the respective side faces or folded around the side faces in order to then completely enclose the side faces of the mobile device all around. In this state, the frame parts of the frame can then be fixedly connected to one another as a case, which can preferably be done in a non-destructively separable manner, as will be described in more detail below, in order to be able to remove the frame from the mobile device again as required.

Preferably, designing the two frame parts of the frame in a substantially L-shaped manner can make it possible to move the connection points close to the corners of the frame and thus also close to the corners of the mobile device, and thus to keep the connection points away in particular from the middle of the bottom side and the top side of the mobile device, where a terminal, a microphone, a speaker of the mobile device may be present, which could otherwise be disrupted or blocked by the connection points. A substantially L-shaped design is understood to mean that the two open ends or legs of the frame parts, which run parallel to one another, extend to different lengths, so that both legs of the frame parts end near a corner of the frame, but not at the same height as one another, which could be considered C-shaped, but having one short and one long leg.

The open ends or legs of the frame parts preferably extend towards one another along the transverse axis, so that the connection points of the frame parts are arranged on the top side and bottom side, as a result of which the sides of the frame can be kept free of the connection points, which can be visually more appealing.

According to one aspect of the invention, the frame parts of the frame are made of metal.

Thus, metal can also be used as the material for the frame, which can provide comparatively good protection due to its hardness. Metal as a frame can also be perceived by the user as visually appealing or as being of particularly high quality.

According to a further aspect of the invention, the frame parts of the frame are designed separately, and the frame parts of the frame are designed to be fixedly connected to one another at two connection points in a non-destructively separable manner.

Thus, the frame can be realized by means of two frame parts separated from one another, which can be pushed individually, preferably laterally, around the side faces of the mobile device and then connected. This can be a concrete possibility for implementation, as already mentioned.

According to a further aspect of the invention, the two connection points are designed to be connected to one another in each case by means of a screw connection.

This can be a secure, durable, and easily detachable type of connection. Here, a frame part can have its own thread per screw, so that a nut as a separate component can be omitted in order to establish the screw connection.

According to a further aspect of the invention, the first connection point has a projection with a through-opening on the side of the first frame part, and a receptacle and a threaded bore on the side of the second frame part, which are designed so that the projection of the first frame part can be arranged within the receptacle of the second frame part and can be held fixed by means of a screw through the through-opening of the first frame part, by screwing the screw into the threaded bore of the second frame part, or vice versa, and the second connection point has a projection with a through-opening on the side of the second frame part, and a receptacle and a threaded bore on the side of the first frame part, which are designed so that the projection of the second frame part can be arranged within the receptacle of the first frame part and can be held fixed by means of a screw through the through-opening of the second frame part, by screwing the screw into the threaded bore of the first frame part, or vice versa.

This can represent a concrete possibility for the implementation of two screw connections. One frame part can have both projections, and the other frame part can have both receptacles, or this can be implemented alternately.

According to a further aspect of the invention, the two connection points are designed to be connected to one another in each case by means of a locking connection.

This can be an alternative possibility for establishing a connection, which can be made relatively easily and quickly by snapping it into place and can also be securely held, but can be more difficult to separate again.

According to a further aspect of the invention, the first connection point has a projection with a through-opening on the side of the first frame part, and a receptacle and a spring-mounted locking element on the side of the second frame part, which are designed so that the projection of the first frame part can be arranged within the receptacle of the second frame part and can be held fixed through the through-opening of the first frame part by means of the spring-mounted locking element, by pressing the locking element into the through-opening of the first frame part by its spring element, or vice versa, and wherein the second connection point has a projection with a through-opening on the side of the second frame part, and a receptacle and a spring-mounted locking element on the side of the first frame part, which are designed so that the projection of the second frame part can be arranged within the receptacle of the first frame part and can be held fixed through the through-opening of the second frame part by means of the spring-mounted locking element, by pressing the locking element into the through-opening of the second frame part by its spring element, or vice versa.

This can represent a concrete possibility for the implementation of two locking connections. One frame part can have both projections, and the other frame part can have both receptacles, or this can be implemented alternately.

According to a further aspect of the invention, the frame parts of the frame are connected to one another in an articulated manner at a first connection point, preferably by means of a hinge, and the frame parts of the frame are designed to be fixedly connected to one another in a non-destructively separable manner at a second connection point.

This can represent an alternative possibility for implementing the frame parts of the frame, so that the frame parts of the frame are already connected to one another, which may simplify handling for a person as a user of the mobile device.

According to a further aspect of the invention, the second connection point has a projection with a through-opening on the side of the first frame part, and a receptacle and a threaded bore on the side of the second frame part, which are designed so that the projection of the first frame part can be arranged within the receptacle of the second frame part and can be held fixed by means of a screw through the through-opening of the first frame part, by screwing the screw into the threaded bore of the second frame part, or vice versa.

This can represent a concrete possibility for implementing a screw connection between two pivoting frame parts of the frame.

According to a further aspect of the invention, the frame parts of the frame have a screw receptacle arranged mirror-symmetrically to the first connection point.

Thus, a further screw can be screwed into the frame or into the respective frame part, which has no function, i.e., does not establish a screw connection, but looks the same as the corresponding screw of the screw connections described above and can thus create optical symmetry for the observer. This can improve the visual impression.

According to a further aspect of the invention, the second connection point has a projection with a through-opening on the side of the first frame part, and a receptacle and a spring-mounted locking element on the side of the second frame part, which are designed so that the projection of the first frame part can be arranged within the receptacle of the second frame part and can be held fixed by means of the spring-mounted locking element through the through-opening of the first frame part, by pressing the locking element by its spring element into the through-opening of the first frame part, or vice versa.

This can represent a concrete possibility for implementing a locking connection between two pivoting frame parts of the frame.

According to a further aspect of the invention, at least one of the two frame elements of the frame has:
a cable cutout where the side faces of the mobile device have a cable terminal,
a microphone cutout where the side faces of the mobile device have a microphone, and/or
a speaker cutout where the side faces of the mobile device have a speaker.

This can prevent the frame parts of the frame from blocking access to the cable terminal of the mobile device or impairing the voice input of the microphone and/or the acoustic output of the speaker of the mobile device.

According to a further aspect of the invention, the frame parts of the frame have key cutouts where the side faces of the mobile device have keys.

This can prevent the frame parts of the frame from blocking accessibility to the keys on the mobile device.

According to a further aspect of the invention, at least one of the two frame elements of the frame has at least one antenna cutout, preferably a plurality of antenna cutouts, where the side faces of the mobile device have an antenna.

As a result, the shielding effect of the frame parts of the frame, particularly in the case of metallic frame parts, on the antenna of the mobile device can be reduced.

According to a further aspect of the invention, the antenna cutout is filled with a cutout plug made of a material transparent to electromagnetic waves, preferably made of polyurethane, particularly preferably made of thermoplastic polyurethane.

This can prevent the penetration of moisture, dirt, and the like into the antenna cutout of the frame parts of the frame, without impairing the electromagnetically transparent effect of the antenna cutout.

According to a further aspect of the invention, the case according to the invention further has an inner case that is designed to enclose the side faces and a rear face of the mobile device with side faces and a rear face at least substantially in a trough shape, wherein the frame parts of the frame are designed to hold the side faces of the inner case in a force-fitting manner on the side faces of the mobile device.

As a result, the case according to the invention can be further developed from a pure bumper, as described above, to a type of hybrid cover, in order to increase the design possibilities. In particular, as a result, the rear or the rear face of the mobile device can also be protected by the case.

According to a further aspect of the invention, the side faces of the inner case are made of a softer material, preferably polyurethane, particularly preferably thermoplastic polyurethane, than the material, preferably polycarbonate, of the rear face of the inner case, preferably in one piece as a two-component injection-molded part.

Due to the comparatively soft and thus elastic material of the side faces, this can improve the sealing effect between the side faces of the inner case and the frame parts of the frame. At the same time, the comparatively hard material can protect the rear face of the mobile device more effectively than if a or the same softer material were used.

Preferably designing the inner case in one piece as a two-component injection-molded part can keep production costs low and ensure the connection between the side faces and the rear face due to the one-piece, i.e., integral, design.

According to a further aspect of the invention, the case according to the invention further has a cover that encloses the rear face of the inner case from its rear, wherein the cover is connected to the inner case in a material-locking manner.

As a result, the design possibilities for the rear of the mobile device can be improved, in particular compared to the side faces and rear face as an injection-molded part, since the cover can be made from a different material and using a different method and then connected to the inner case in a material-locking manner, in particular glued on. This can improve the design freedom both in terms of protecting the rear of the mobile device and the visual design of the rear of the cover.

According to a further aspect of the invention, the cover has side faces that partially enclose the side faces of the inner case, wherein an edge of the side faces of the cover is arranged between the side faces of the inner case and the frame parts of the frame.

Thus, the side faces of the cover partially grip the side faces of the inner case, to such an extent that the edge of the side faces of the cover is arranged between the side faces of the inner case and the frame parts of the frame, and thus the edge of the side faces of the cover is held in a force-fitting manner by the frame parts of the frame on the side faces of the inner case. This can prevent the cover fastened in a material-locking manner from detaching from the rear face of the inner case in the course of the use of the cover if the edge of the side faces of the cover are exposed and could as a result be grasped from behind and thereby gradually detached. However, since the edge of the side faces of the cover is covered by the frame parts of the frame and is thus not accessible, this can be reliably prevented, which benefits the longevity of the case.

According to a further aspect of the invention, the side faces of the inner case facing away from the rear face have an inwardly bent edge, which is designed to grip the mobile device on its front on the edge.

The side faces of the inner case or at least its inwardly bent edge are thus designed to be sufficiently elastic in order to be bent or pressed in so as to press the mobile device into the inner case and to have it enclosed at the edges by the spring-back edge of the side faces of the inner case, and as a result held in a form-fitting and force-fitting manner. This hold can then be improved by subsequently placing the frame parts of the frame around the side faces of the inner case as described above and fixedly connecting them, as a result of which the side faces of the inner case are pressed together and prevented from bending or expanding outwards. This can constitute a simple and very secure possibility for keeping the mobile device within the inner case of the case according to the invention.

According to a further aspect of the invention, the side faces of the inner case have a circumferential trough towards the outside, at least in sections, wherein the frame parts of the frame have projections towards the inside, at least in sections, which are designed to engage in the trough of the side faces of the inner case.

As a result, a form-fitting connection can be created between the inner case and the frame parts of the frame, which can improve the hold between the inner case and the frame.

According to a further aspect of the invention, the side faces of the inner case in each case have a screw receptacle, preferably an indentation, on the outside where the threaded bores of the first frame part and/or the second frame part are arranged.

Thus, in each case the end of the screw, opposite the screw head, which can protrude inwards from the threaded bores of a frame part, can extend into the screw receptacle or into the indentation in the side faces of the inner case, as a result of which damage to the side face of the inner case by the screw can be prevented.

According to a further aspect of the invention, the frame parts of the frame have key cutouts where the side faces of the mobile device have keys, wherein the side faces of the inner case have key elements that are designed to extend outwards through the key cutouts of the frame parts of the frame, so that pressing the key elements can be transferred to the corresponding keys of the mobile device.

Accordingly, the key elements of the side faces of the inner case can sufficiently transfer the force of pressing by a person to the corresponding key of the mobile device located underneath, in order to ensure the operability of the keys of the mobile device despite the use of the case according to the invention. The key elements can be formed in one piece with the side faces of the inner case, which can keep production costs low. Alternatively, separately produced key elements can be used and connected to the side faces of the inner case, as will be described in more detail below. In this case, the key element can be designed to be as rigid as possible, preferably made of metal. The use of a metallic frame with metallic key elements can also improve the visual appearance for the user, as described above.

According to a further aspect of the invention, the key elements, preferably made of metal, are produced separately and arranged in key cutouts in the side faces of the inner case, preferably held in a form-fitting and/or force-fitting manner, particularly preferably clipped in by means of an undercut.

This can constitute a concrete possibility for implementation, as described above. Holding the separate key elements in the key cutouts on the side faces of the inner case with a locking or clip connection can be a simple but durable possibility for connecting them.

According to a further aspect of the invention, the rear face of the inner case has a Mag-Safe adapter.

As a result, the corresponding properties and functions of a magnetic coupling or contactless charging of the mobile device can be allowed, even when the inner case is used.

According to a further aspect of the invention, the rear face of the inner case has a camera cutout, preferably with a reinforced edge, where the rear face of the mobile device has a rear camera.

This can prevent the rear face of the inner case from concealing the rear camera of the mobile device and thus rendering it unusable.

According to a further aspect of the invention, the side faces of the inner case have:
a cable cutout where the side faces of the mobile device have a cable terminal,
a microphone cutout where the side faces of the mobile device have a microphone, and/or
a speaker cutout where the side faces of the mobile device have a speaker.

This can prevent the side faces of the inner case from blocking access to the cable terminal of the mobile device or impairing the voice input of the microphone and/or the acoustic output of the speaker of the mobile device.

According to a further aspect of the invention, the side faces of the inner case have at least one antenna cutout, preferably a plurality of antenna cutouts, where the side faces of the mobile device have an antenna.

As a result, a shielding effect of the side faces of the inner case on the antenna of the mobile device can be reduced.

According to a further aspect of the invention, the antenna cutout of the side faces of the inner case is arranged congruently with the antenna cutout of the frame elements of the frame.

This can further reduce the shielding effect of the side faces of the inner case and frame. An additional cutout plug for the antenna cutout in the side faces of the inner case can be omitted, since the antenna cutout in the side faces of the inner case can be covered and protected by a cutout plug, arranged on the outside above it, of the frame.

According to a further aspect of the invention, the case according to the invention has a cover that is designed to enclose the rear face of the inner case from its rear, wherein the cover is designed to be connected to the frame parts of the frame in a non-destructively separable manner.

As a result, a cover can be provided in an alternative manner to that described above, in order to cover and protect the rear face of the mobile device. Due to the non-destructive separability of the cover and the frame or its frame parts, the cover can be replaced by the user in order to change the function and/or appearance of the cover. Thus, differently designed covers can be used alternatively. A purely protective cover can also be exchanged for a functional cover such as a card holder, also called a “wallet.” This can increase the scope for design and use.

The non-destructive separability of the cover and the frame or its frame parts can be effected by means of any suitable mechanical or other means. For example, a locking connection can be used so that the cover with corresponding protruding locking elements can be pressed into corresponding locking receptacles in the frame, held securely there, and pulled off the frame again with sufficient force. There can also be parallel running grooves on the frame into which the opposite rims of the cover can be inserted, wherein this groove-rim connection can be designed to be sufficiently tight in order to achieve a form-fitting connection in addition to the force fit. Alternatively, a magnetic connection can be used, as described in more detail below.

According to a further aspect of the invention, the frame parts of the frame are made of metal, and an edge of the cover is at least partially, preferably completely, magnetic.

This can be a simple connection that, when using sufficiently strong magnets, is secure and can be quickly connected or disconnected.

According to a further aspect of the invention, the cover has a camera cutout, preferably with a reinforced edge, where the rear face of the mobile device has a rear camera.

This can prevent the rear face of the cover from concealing the rear camera of the mobile device and thus rendering it unusable.

According to a further aspect of the invention, the case according to the invention further has a camera cover that is designed to be arranged around a rear camera of the rear face of the mobile device, wherein the camera cover has at least one camera cutout where the rear face of the mobile device has the rear camera.

As a result, a separate element in the form of a camera cover can be created in order to protect the rear camera of the mobile device. For this purpose, a comparatively hard material, comparable to the rear face of the inner case, can be used.

According to a further aspect of the invention, the cover is designed to hold the camera cover in a form-fitting manner on the rear face of the mobile device by means of the camera cutout, preferably by means of a reinforced edge of the camera cutout.

This can constitute a possibility for holding the camera cover on the rear face of the mobile device. For this purpose, the camera cover can be inserted or placed into the camera cutout of the cover, in order to then connect the cover together with the camera cover to the frame and thus position the camera cover in front of the rear camera of the mobile device.

According to a further aspect of the invention, the camera cover is designed to be held in a material-locking manner on the rear face of the mobile device.

This can constitute an alternative possibility for assembling the camera cover, in particular by gluing it on.

According to a further aspect of the invention, the frame parts of the frame have an elastic lining on the inside.

As a result, a tight seal between the comparatively rigid frame or its frame parts and the side faces of the mobile device can be created. For this purpose, the inner side of the frame or its frame parts can be provided with the elastic material of the elastic lining. This can be effected in a material-locking manner or as a separate component. The same material as the side faces of the inner case can be used for this purpose.

According to a further aspect of the invention, the frame parts of the frame have an inwardly bent edge on both sides, which is designed to grip the mobile device on its rear and on its front at the edge.

Thus, in this case, the mobile device can be gripped directly by the frame on both sides, in order to hold the frame or the case to the smartphone in a form-fitting manner.

According to a further aspect of the invention, the cover has a Mag-Safe adapter.

As a result, the properties and advantages described above can also be implemented by means of the adapter.

### BRIEF DESCRIPTION OF THE DRAWINGS

Several exemplary embodiments and further advantages of the invention are illustrated and explained in more detail below, purely schematically, in connection with the following figures, in which:

FIG. 1 is a perspectival schematic exploded representation of a case according to the invention, according to a first exemplary embodiment having a mobile device;

FIG. 2 is a perspectival schematic representation of unconnected frame parts of the case according to the invention of FIG. 1;

FIG. 3 is a perspectival schematic representation of an inner case of the case according to the invention of FIG. 1;

FIG. 4 is a perspectival representation of the case according to the invention of FIG. 1 mounted on the mobile device with the frame closed;

FIG. 5 is a perspectival view of a case according to a second exemplary embodiment having an open frame, obliquely from above;

FIG. 6 is the representation of FIG. 5 obliquely from below;

FIG. 7 is a perspectival view of a closed frame of a case according to the invention according to a third exemplary embodiment;

FIG. 8 is a cross-section of a detail view of FIG. 7;

FIG. 9 is a perspectival schematic exploded representation of a case according to the invention according to a fourth exemplary embodiment having a mobile device;

FIG. 10 is a perspectival view of the case according to the invention of FIG. 9 mounted on the mobile device without a cover;

FIG. 11 is a cross-section of a detail view of FIG. 10;

FIG. 12 is a perspectival view of the case according to the invention of FIG. 9 mounted on the mobile device having a cover; and

FIG. 13 is a cross-section of a detail view of FIG. 12.

### DETAILED DESCRIPTION OF THE DRAWINGS

The figures are viewed in Cartesian coordinates. A longitudinal axis X is shown, which can also be denoted as depth X or as length X. A transverse axis Y, which can also be denoted as width Y, extends perpendicular to the longitudinal axis X. A vertical axis Z extends perpendicular to both the longitudinal axis X and the transverse axis Y, which can also be denoted as the height Z and which corresponds to the direction of gravity or the gravitational force. The longitudinal axis X and the transverse axis Y together form the horizontal X, Y, which can also be denoted as horizontal plane X, Y.

In the following, various covers 1-4 according to the invention for mobile devices 5 are considered using the example of a smartphone 5. In terms of the orientation of the case 1-4 or its individual elements along with the smartphone 5, it is assumed that the case 1-4 or its elements along with the smartphone 5 are held in front of a person as the user with their hand and that the person is in an upright position, i.e., looking at a touch-sensitive screen 51 of the smartphone 5 in the horizontal X, Y. Accordingly, a top side 1a, 2a, 3a, 5a always points upwards along the vertical axis Z, and a bottom side 1b, 2b, 3b, 5b always points downwards along the vertical axis Z. A left side 1c, 2c, 3c, 5c always points to the left along the transverse axis Y, and a right side 1d, 2d, 3d, 5d always points to the right along the transverse axis Y. A rear or an outer side 2e, 3e, 5e always points backwards along the longitudinal axis X, and a front 2f, 3f, 5f always points forwards towards the user along the longitudinal axis X.

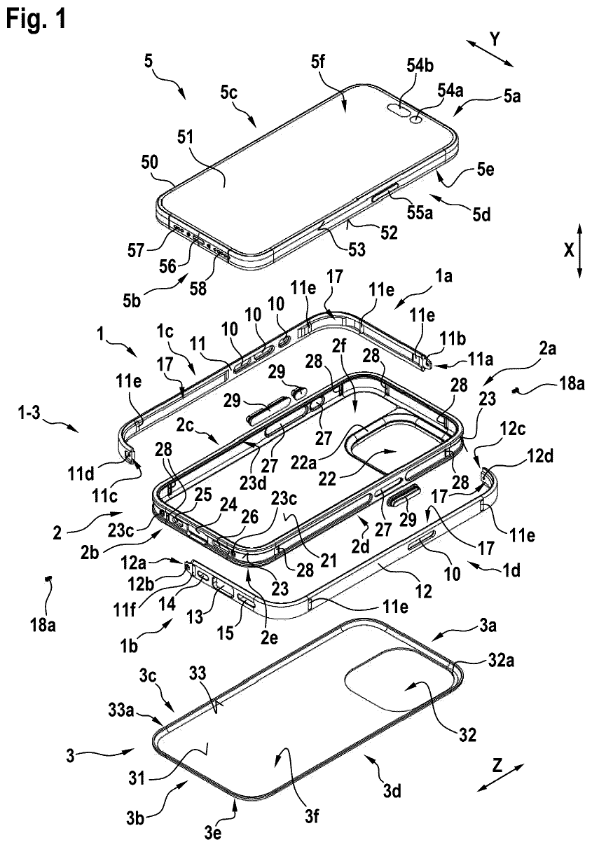

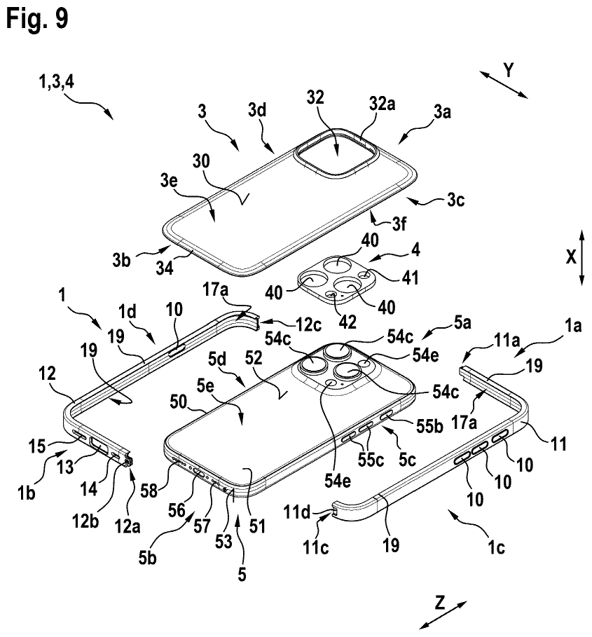

The smartphone 5 has a frame 50, which can also be denoted as housing 50 and accommodates the components of the smartphone 5 and encloses them on the outside. The front 5f of the smartphone 5 has the already mentioned touch-sensitive screen 51 (see, for example, FIG. 1), opposite which the rear face 52 is arranged along the longitudinal axis X (see, for example, FIG. 9). The touch-sensitive screen 51 and the rear face 52 are connected by four side faces 53. The front 5f further has a front camera 54a and a face recognition sensor 54b in the upper region. Opposite, the rear face 52 has three rear cameras 54c along with a flash 54d and a LIDAR sensor 54e. The right side 5d of the smartphone 5 has a side key 55a, which can be used as an on/off key 55a. The left side 5c of the smartphone 5 has an action key 55b and below it a pair of volume keys 55c; see, for example, FIG. 9. On the bottom side 5b, a cable terminal 56 in the form of a USB-C port 56 is arranged in the middle along the transverse axis Y, along with a microphone 57 to the left and a speaker 58 to the right; see, for example, FIG. 1.

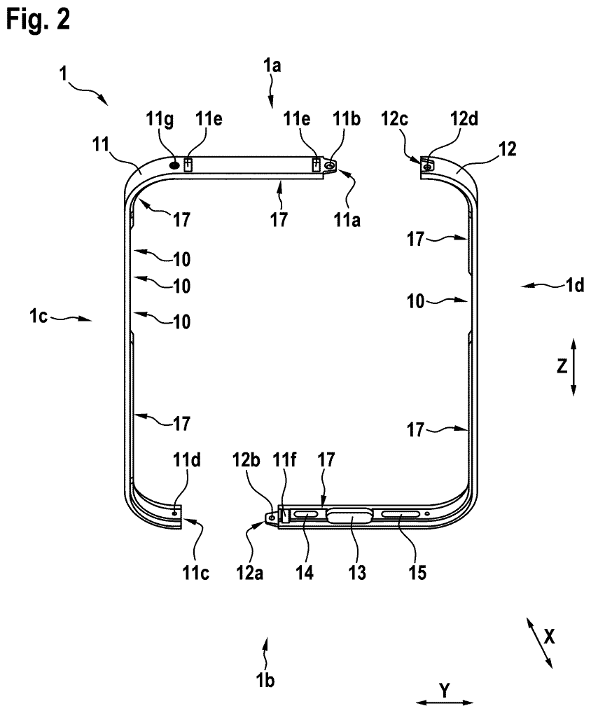

In order to protect the smartphone 5, the case 1-3 according to the invention according to the first exemplary embodiment has a frame 1, which can also be denoted as outer case 1. The frame 1 substantially consists of a first frame part 11 and a second frame part 12, which in each case are substantially L-shaped; see, for example, FIG. 2. The two frame parts 11, 12 are made of metal. The first frame part 11 has three key cutouts 10 for the action key 55b and for the volume keys 55c of the smartphone 5. The second frame part 12 has a key cutout 10 for the side key 55a or for the on/off key 55a. Towards the inside, both frame parts 11, 12 have projections 17 that extend longitudinally or circumferentially in sections. The lower, more elongated leg of the L-shaped second frame part 12 has a cable cutout 13, a microphone cutout 14, and a speaker cutout 15 corresponding to the cable terminal 56, the microphone 57, and the speaker 58 of the smartphone 5, so as not to conceal them.

The two frame parts 11, 12 of the frame 1 can in each case be placed laterally around the side faces 53 of the smartphone 5 by the person along the transverse axis Y and then fixedly connected to one another. For this purpose, a first connection point 11a-11b, 12c-12d, 18a has a projection 11a with a through-opening 11b on the side of the first frame part 11, and a receptacle 12c and a threaded bore 12d on the side of the second frame part 12. The projection 11a of the first frame part 11 is arranged within the receptacle 12c of the second frame part 12 and is held fixed by means of a screw 18a through the through-opening 11b of the first frame part 11, by screwing the screw 18a into the threaded bore 12d of the second frame part 12. Likewise, a second connection point 11c-11d, 12a-12b, 18a has a projection 12a with a through-opening 12b on the side of the second frame part 12, and a receptacle 11c and a threaded bore 11d on the side of the first frame part 11, which are designed so that the projection 12a of the second frame part 12 can be arranged within the receptacle 11c of the first frame part 11 and can be held fixed by means of a screw 18a through the through-opening 12b of the second frame part 12, by screwing the screw 18a into the threaded bore 11d of the first frame part 11.

Thus, the two frame parts 11, 12 can be joined around the side faces 53 of the smartphone 5 and then connected to one another in a fixed but non-destructively separable manner by means of two screw connections at the two connection points 11a-11d, 12a-12d, 18a. This can make it possible to make the frame parts 11, 12 of the frame 1 from metal and yet still grip the side faces 53 of the smartphone 5.

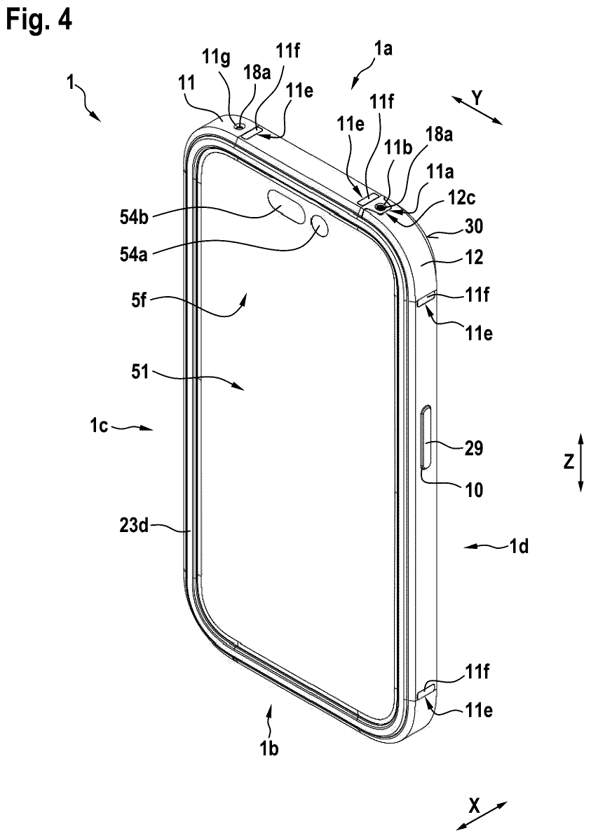

In order not to provide an asymmetrical impression or appearance for the person due to the screws 18a being visible from the outside, the top side 1a of the frame 1 or its first frame part 11 has a screw receptacle 11g, arranged symmetrically to the transverse axis Y (see, for example, FIG. 4), into which a screw 18a can also be screwed, but without having a technical function.

The case 1-3 according to the invention according to the first exemplary embodiment further has an inner case 2, which has comparatively soft or elastic side faces 23 and a comparatively rigid or hard rear face 20. The side faces 23 of the inner case 2 rest on the side faces 53 of the smartphone 5, and the inner side 2f of the rear face 20 as the inner side face 21 rests on the rear face 52 of the smartphone 5.

The side faces 23 of the inner case 2 have, in sections, longitudinally extending or circumferential troughs 23b in the form of grooves 23b, which are formed by lateral rims 23a and correspond to the projections 17 of the frame 1. Thus, the projections 17 of the frame 1 or its frame parts 11, 12 can engage from the outside into the troughs 23b of the side faces 23 of the inner case 2 and thus be held together along the longitudinal axis X in a form-fitting manner. At the same time, the side faces 23 and the rear face 20 of the inner case 2 can accommodate the smartphone 5. The side faces 23 of the inner case 2 are pressed by the connected frame 1 onto the side faces 53 of the smartphone 5, as a result of which the inner case 2 and the frame 1 are held on the smartphone 5 in a force-fitting manner. In addition, an inwardly bent edge 23d protrudes as a clasp 23d over the rim (not designated) between the side faces 53 and the touch-sensitive screen 51 of the smartphone 5, as a result of which an additional form fit is achieved along the longitudinal axis X. As a result, the case 1-3 can be securely connected to the smartphone 5.

The side faces 23 of the inner case 2 have a screw receptacle 23c in the form of an indentation 23c at the corresponding location, so that the screws 18a can in each case extend through the threaded bore 11d or through the screw receptacle 11g, without damaging the side faces 23 of the inner case 2.

The side faces 23 of the inner case 2 in turn have key cutouts 27 at the corresponding locations, into which in each case metallic key elements 29 are clipped (see, for example, FIG. 1) in order to protrude outwards through the key cutouts 10 of the frame 1 and thus be accessible to the user. Thus, the user can press the key elements 29 of the inner case 2 instead of the keys 55a-55c of the smartphone 5, since the pressure exerted can be transferred via the key elements 29 of the inner case 2 to the keys 55a-55c of the smartphone 5.

The side faces 23 of the inner case 2 also have a cable cutout 24, a microphone cutout 25, and a speaker cutout 26 at the corresponding locations so as not to conceal them.

The side faces 23 of the inner case 2 have a plurality of antenna cutouts 28, which reduce shielding of the antenna (not shown) of the smartphone 5, which can occur due to the inner case 2. Congruent with the antenna cutouts 28 of the side faces 23 of the inner case 2, the metallic frame elements 11, 12 of the frame 1 in turn have antenna cutouts 11e, which are in each case filled and closed by a cutout plug 11f, in order to keep moisture, dirt, and the like away from the antenna cutouts 11e, 28. In particular, the antenna cutouts 11e of the metallic frame elements 11, 12 can reduce the shielding of the antenna of the smartphone 5.

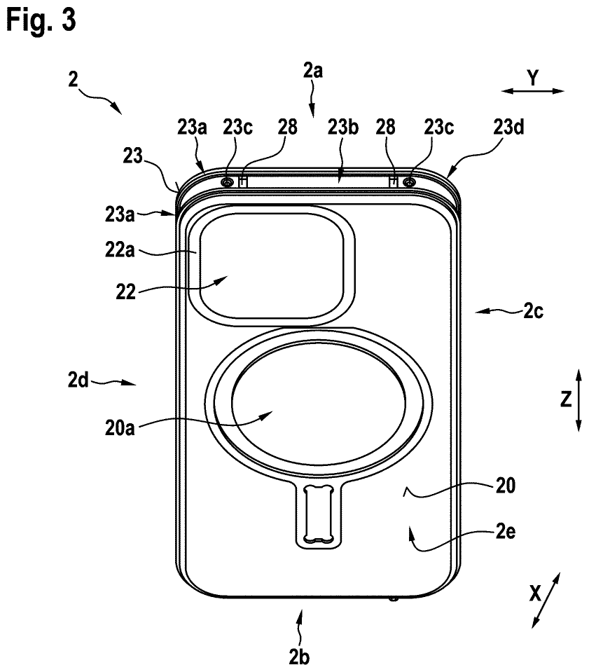

The rear face 20 of the inner case 2 has a Mag-Safe adapter 20a in the form of magnetic elements (see, for example, FIG. 3) in order to make a Mag-Safe function of the rear face 52 of the smartphone 5 available through the rear face 20 of the inner case 2.

The rear face 20 of the inner case 2 also has a camera cutout 22 with a reinforced edge 22a, which is arranged corresponding to the rear cameras 54c, the flash 54d, and the LIDAR sensor 54e of the rear face 54 of the smartphone 5.

The case 1-3 according to the invention according to the first exemplary embodiment also includes a cover 3, which is comparatively rigid and stable. The cover 3 in turn has a camera cutout 32, which is designed and arranged to correspond to the camera cutout 22 of the rear face 20 of the inner case 2, so that an edge 32a of the camera cutout 32 of the cover 3 is congruent with the camera cutout 22 of the rear face 20 of the inner case 2. The cover 3 can also have a Mag-Safe adapter (not shown) in addition to or as an alternative to the rear face 20 of the inner case 2.

The cover 3 projects with side faces 33 slightly over the side faces 23 of the inner case 2, so that an edge 33a or a rim 33a of the side faces 33 of the cover 3 lies between the side faces 23 of the inner case 2 and the frame parts 11, 12 of the frame 1 and can thus be covered on the outside by the frame parts 11, 12 of the frame 1 and held on the side faces 23 of the inner case 2 in a force-fitting manner. At the same time, an inner side face 31 of the cover 3 is provided with adhesive and thus held on the rear face 20 of the inner case 2 primarily in a material-locking manner. An opposite rear face 30 of the cover 3 thus faces outwards together with the frame 1 and can be designed to be more visually appealing than the rear face 52 of the smartphone 5 itself, without restricting its operation and functions.

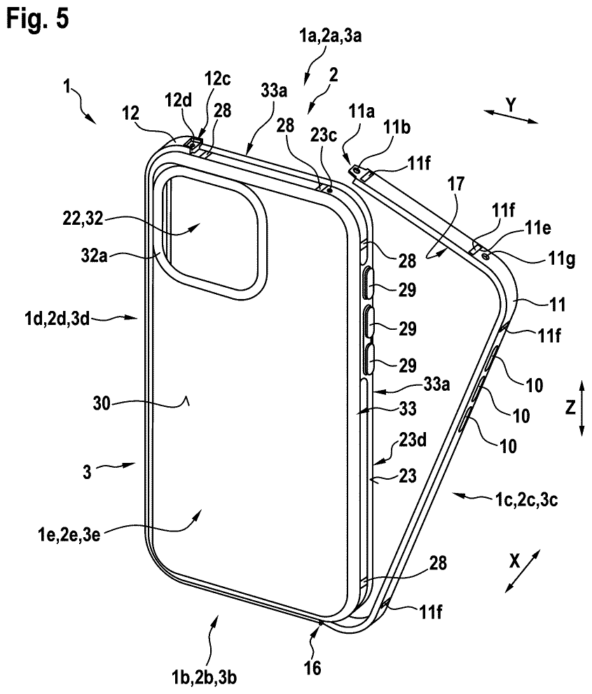

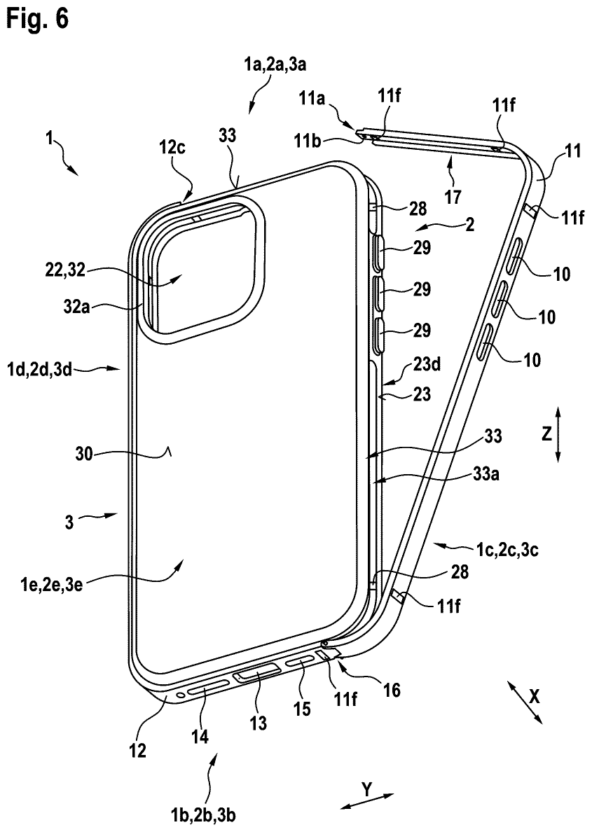

FIGS. 5 and 6 show a case 1-3 according to the invention according to a second exemplary embodiment. In this case, the two frame parts 11, 12 of the frame 1 are movably connected to one another. This is realized by a hinge 16, which forms the first connection point, so that the two frame parts 11, 12 can be folded against one another.

Accordingly, the two frame parts 11, 12 of the frame 1 can be opened up, so that the second frame part 12 can then be joined around the side faces 23 of the inner case 2, which already accommodates the smartphone 5 as described above (not shown), and subsequently the first frame part 11 can be closed and connected as described above.

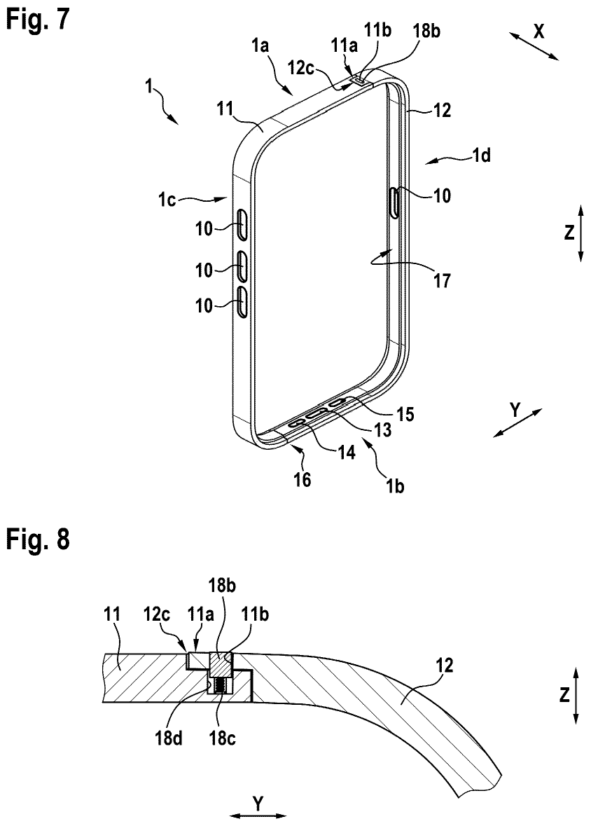

FIGS. 7 and 8 show a case 1-3 according to the invention according to a third exemplary embodiment. In this case, a hinge 16 is also used. The other, second connection point 11a-11b, 12c-12d, 18a has a projection 11a with a through-opening 11b on the side of the first frame part 11, and a receptacle 12c and a spring-mounted locking element 18b, 18c, in the form of a bolt 18b having a spring element 18c, on the side of the second frame part 12, which are designed so that the projection 11a of the first frame part 11 can be arranged within the receptacle 12c of the second frame part 12 and can be held fixed by means of the spring-mounted locking element 18b, 18c through the through-opening 11b of the first frame part 11, by pressing the locking element 18b by its spring element 18c into the through-opening 11b of the first frame part 11. The spring element 18c is arranged within a spring element receptacle 18d of the first frame part 11. This can simplify assembly for the user.

According to a fourth exemplary embodiment of a case 1, 3, 4 according to the invention, the inner case 2 described above is omitted. In order to nevertheless achieve a tight seal between the inner sides of the metallic frame parts 11, 12 of the frame 1 and the side faces 53 of the smartphone 5, the frame parts 11, 12 of the frame 1 have an elastic lining 17a on the inside made of the material of the side faces 23 of the inner case 2, which is applied there in a material-locking manner. This can improve the force-fitting hold of the frame 1 on the smartphone 5, as described above.

The frame parts 11, 12 of the frame 1 also have in each case an inwardly bent edge 19 on both sides towards the front and back as clasps 19 along the longitudinal axis X, in order to grip the rear 5e and the front 5f of the smartphone 5 in each case at the edge and thus additionally achieve a form fit. As a result, the frame 1 can be securely connected to the smartphone 5. The inwardly bent edge 19 of the frame parts 11, 12 of the frame 1 protrudes slightly beyond the smartphone 5 on both sides along the longitudinal axis X; see, for example, FIG. 11.

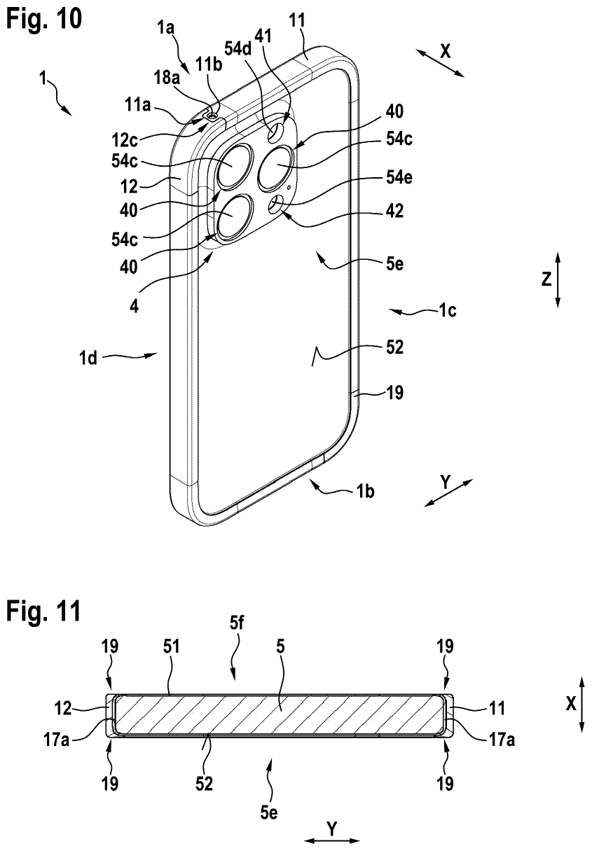

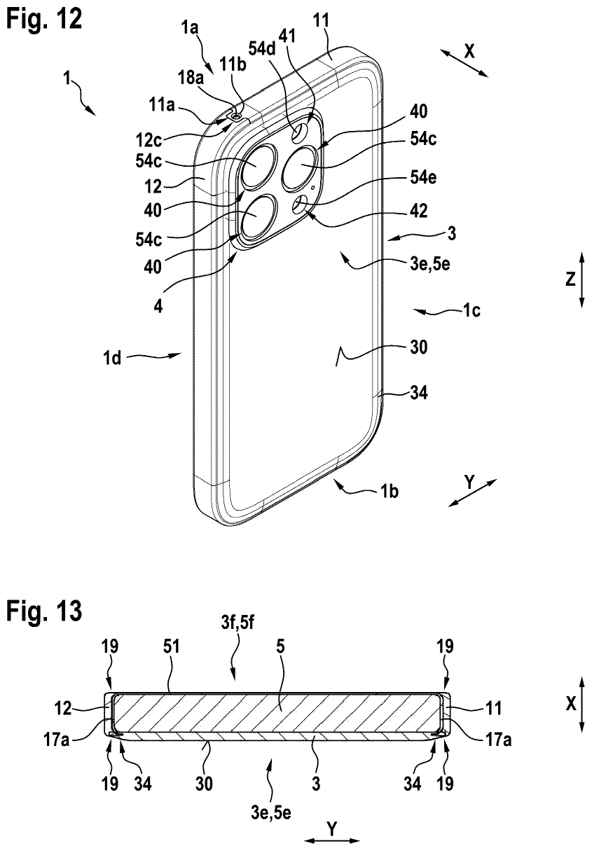

According to the fourth exemplary embodiment, a separate camera cover 4 is provided, which consists of the same material as the rear face 20 of the inner case 2. The camera cover 4 in each case has a corresponding camera cutout 40 where the smartphone 5 has one of the three rear cameras 54c; see, for example, FIG. 9. Furthermore, the camera cover 4 has a flash cutout 41 matching the flash 54d and a LIDAR sensor cutout 42 matching the LIDAR sensor 54e of the mobile device 5. The camera cover 4 is arranged and glued on the rear face 52 of the smartphone 5 around the rear cameras 54c, the flash 54d, and the LIDAR sensor 54e, in order to protect them; see, for example, FIGS. 10 and 12.

In this case, the cover 3 is designed to be completely flat and has a circumferential edge 34 in which magnets (not shown) are incorporated. As a result, the cover 3 can be held magnetically on the inwardly bent edge 19 of the frame parts 11, 12 of the frame 1 (see, for example, FIG. 13), which can ensure a secure hold with suitably strong magnetic forces, which at the same time can be quickly and easily lifted again by the user with sufficient force, in order to remove or replace the cover 3 as required. For example, a purely decorative cover 3 can be exchanged for an also functional cover 3 such as a card holder, also called a “wallet.”

In the case of a purely decorative cover 3, this can also have a Mag-Safe adapter (not shown), in order to allow the Mag-Safe function despite the use of the adapter 3.

### LIST OF REFERENCE SIGNS (PART OF THE DESCRIPTION)

X Longitudinal axis; depth; length
Y Transverse axis; width
Z Vertical axis; height
X, Y Horizontal; horizontal plane
1-4 Case for mobile devices 5 or for smartphones 5
1 Frame; outer case
1a Top side
1b Bottom side
1c Left side
1d Right side
10 Key cutouts
11 First frame part
11a Projection
11b Through-opening
11c Receptacle
11d Threaded bore
11e Antenna cutouts
11f Cutout plug
11g Screw receptacle
12 Second frame part
12a Projection
12b Through-opening
12c Receptacle
12d Threaded bore
13 Cable cutout
14 Microphone cutout
15 Speaker cutout
16 Hinge
17 Projections
17a Elastic lining
18a Screws
18b Locking elements; bolts
18c Spring elements
18d Spring element receptacles
19 Inwardly curved edges; clasps
2 Inner case
2a Top side
2b Bottom side
2c Left side
2d Right side
2e Rear or outer side
2f Inner side
20 Rear face
20a Mag-Safe adapter
21 Inner side face
22 Camera cutout
22a Reinforced edge of the camera cutout 22
23 Side faces
23a Rim
23b Troughs; grooves
23c Screw receptacles; indentations
23d Inwardly curved edge; clasp
24 Cable cutout
25 Microphone cutout
26 Speaker cutout
27 Key cutouts
28 Antenna cutouts
29 Key elements
3 Cover
3a Top side
3b Bottom side
3c Left side
3d Right side
3e Rear or outer side
3f Inner side
30 Rear face
31 Inner side face
32 Camera cutout
32a Edge of the camera cutout 32
33 Side faces
33a Edge or rim of the side face 33
34 Edge of cover 3
4 Camera cover
40 Camera cutouts
41 Flash cutout
42 LIDAR sensor cutout
5 Mobile device; smartphone
5a Top side
5b Bottom side
5c Left side
5d Right side
5e Rear
5f Front
50 Frame; housing
51 Touch-sensitive screen
52 Rear face
53 Side faces
54a Front camera
54b Face recognition sensor
54c Rear cameras
54d Flash
54e LIDAR sensor
55a Side key; on/off key
55b Action key
55c Volume keys
56 Cable terminal; USB-C port
57 Microphone
58 Speaker

1. A case for a mobile device comprising:
a frame including:
a first substantially L-shaped frame part, and
a second substantially L-shaped frame part,
wherein the first substantially L-shaped frame part and the second substantially L-shaped frame part are designed to completely enclose side faces of the mobile device all around and to be fixedly connected to one another.

2. The case according to claim 1, wherein the frame parts of the frame are made of metal.

3. The case according to claim 1, wherein the frame parts of the frame are designed separately, and
wherein the frame parts of the frame are designed to be fixedly connected to one another at two connection points in a non-destructively separable manner.

4. The case according to claim 3, wherein the two connection points are designed to be connected to one another in each case by means of a screw connection.

5. The case according to claim 4, wherein the first connection point has a projection with a through-opening on the side of the first frame part, and a receptacle and a threaded bore on the side of the second frame part, which are designed so that the projection of the first frame part can be arranged within the receptacle of the second frame part and can be held fixed by means of a screw through the through-opening of the first frame part, by screwing the screw into the threaded bore of the second frame part, or vice versa, and
wherein the second connection point has a projection with a through-opening on the side of the second frame part, and a receptacle and a threaded bore on the side of the first frame part, which are designed so that the projection of the second frame part can be arranged within the receptacle of the first frame part and can be held fixed by means of a screw through the through-opening of the second frame part, by screwing the screw into the threaded bore of the first frame part, or vice versa.

6. The case according to claim 3, wherein the two connection points are designed to be connected to one another in each case by means of a locking connection.

7. The case according to claim 6, wherein the first connection point has a projection with a through-opening on the side of the first frame part, and a receptacle and a spring-mounted locking element on the side of the second frame part, which are designed so that the projection of the first frame part can be arranged within the receptacle of the second frame part and can be held fixed by means of the spring-mounted locking element through the through-opening of the first frame part, by pressing the locking element by its spring element into the through-opening of the first frame part, or vice versa, and
wherein the second connection point has a projection with a through-opening on the side of the second frame part, and a receptacle and a spring-mounted locking element on the side of the first frame part, which are designed so that the projection of the second frame part can be arranged within the receptacle of the first frame part and can be held fixed by means of the spring-mounted locking element through the through-opening of the second frame part, by pressing the locking element by its spring element into the through-opening of the second frame part, or vice versa.

8. The case according to claim 1, wherein the frame parts of the frame are connected to one another in an articulated manner at a first connection point by means of a hinge, and
wherein the frame parts of the frame are designed to be fixedly connected to one another in a non-destructively separable manner at a second connection point.

9. The case according to claim 8, wherein the second connection point has a projection with a through-opening on the side of the first frame part, and a receptacle and a threaded bore on the side of the second frame part, which are designed so that the projection of the first frame part can be arranged within the receptacle of the second frame part and can be held fixed by means of a screw through the through-opening of the first frame part, by screwing the screw into the threaded bore of the second frame part, or vice versa.

10. The case according to claim 5, wherein the frame parts of the frame have a screw receptacle arranged mirror-symmetrically to the first connection point.

11. The case according to claim 8, wherein the second connection point has a projection with a through-opening on the side of the first frame part, and a receptacle and a spring-mounted locking element on the side of the second frame part, which are designed so that the projection of the first frame part can be arranged within the receptacle of the second frame part and can be held fixed by means of the spring-mounted locking element through the through-opening of the first frame part, by pressing the locking element by its spring element into the through-opening of the first frame part, or vice versa.

12. The case according to claim 1, wherein at least one of the two frame elements of the frame comprises:
a cable cutout where the side faces of the mobile device have a cable terminal,
a microphone cutout where the side faces of the mobile device have a microphone, and/or
a speaker cutout where the side faces of the mobile device have a speaker.

13. The case according to claim 1, wherein the frame parts of the frame have key cutouts where the side faces of the mobile device have keys.

14. The case according to claim 1, wherein at least one of the two frame elements of the frame has at least one antenna cutout where the side faces of the mobile device have an antenna.

15. The case according to claim 14, wherein the antenna cutout is filled with a cutout plug made of a material transparent to electromagnetic waves.

16. The case according to claim 1, further having an inner case that is designed to enclose the side faces and a rear face of the mobile device with side faces and a rear face at least substantially in a trough shape, and
wherein the frame parts of the frame are designed to hold the side faces of the inner case in a force-fitting manner on the side faces of the mobile device.

17. The case according to claim 16, wherein the side faces of the inner case are made of a softer material than the material of the rear face of the inner case.

18. The case according to claim 17, further having a cover that encloses the rear face of the inner case from its rear,
wherein the cover is connected to the inner case in a material-locking manner.

19. The case according to claim 18, wherein the cover has side faces that partially enclose the side faces of the inner case,
wherein an edge of the side faces of the cover is arranged between the side faces of the inner case and the frame parts of the frame.

20. The case according to claim 19, wherein the side faces of the inner case facing away from the rear face have an inwardly bent edge, which is designed to grip the mobile device on its front at the edge.

21. The case according to claim 20, wherein the side faces of the inner case have a circumferential trough towards the outside, at least in sections, and
wherein the frame parts of the frame have projections towards the inside at least in sections, which are designed to engage in the trough of the side faces of the inner case.

22. The case according to claim 21, wherein the side faces of the inner case in each case have a screw receptacle towards the outside where the threaded bores of the first frame part and/or the second frame part are arranged.

23. The case according to claim 22, wherein the frame parts of the frame have key cutouts where the side faces of the mobile device have keys, and
wherein the side faces of the inner case have key elements that are designed to extend outwards through the key cutouts of the frame parts of the frame, so that pressing the key elements can be transferred to the corresponding keys of the mobile device.

24. The case according to claim 23, wherein the key elements are produced separately and arranged in key cutouts of the side faces of the inner case.

25. The case according to claim 24, wherein the rear face of the inner case has a Mag-Safe adapter.

26. The case according to claim 25, wherein the rear face of the inner case has a camera cutout where the rear face of the mobile device has a rear camera.

27. The case according to claim 26, wherein the side faces of the inner case have:
a cable cutout where the side faces of the mobile device have a cable terminal,
a microphone cutout where the side faces of the mobile device have a microphone, and/or
a speaker cutout where the side faces of the mobile device have a speaker.

28. The case according to claim 27, wherein the side faces of the inner case have at least one antenna cutout where the side faces of the mobile device have an antenna.

29. The case according to claim 28, wherein the antenna cutout of the side faces of the inner case is arranged congruently with the antenna cutout of the frame elements of the frame.

30. The case according to claim 1 further having a cover, which is designed to enclose the rear face of the inner case from its rear,
wherein the cover is designed to be connected to the frame parts of the frame in a non-destructively separable manner.

31. The case according to claim 30, wherein the frame parts of the frame are made of metal, and
wherein an edge of the cover is designed to be at least partially magnetic.

32. The case according to claim 31, wherein the cover has a camera cutout where the rear face of the mobile device has a rear camera.

33. The case according to claim 1 further having a camera cover, which is designed to be arranged around a rear camera of the rear face of the mobile device,
wherein the camera cover has at least one camera cutout where the rear face of the mobile device has the rear camera.

34. The case according to claim 33, wherein the cover is designed to hold the camera cover in a form-fitting manner on the rear face of the mobile device by means of the camera cutout.

35. The case according to claim 33, wherein the camera cover is designed to be held in a material-locking manner on the rear face of the mobile device.

36. The case according to claim 35, wherein the frame parts of the frame have an elastic lining on the inside.

37. The case according to claim 36, wherein the frame parts of the frame have an inwardly bent edge on both sides, which is designed to grip the mobile device on its rear and on its front at the edge.

38. The case according to claim 37, wherein the cover has a Mag-Safe adapter.
